(19) United States
(12) Patent Application Publication
(10) Pub. No.: US 2013/0152749 A1
(43) Pub. Date: Jun. 20, 2013

(54) CUTTING APPARATUS AND METHOD

(71) Applicants: Noreen Salador, Essex (GB); Dennis G. Salador, Essex (GB)

(72) Inventors: Noreen Salador, Essex (GB); Dennis G. Salador, Essex (GB)

(21) Appl. No.: 13/805,949

(22) PCT Filed: Jun. 21, 2011
(86) PCT No.: PCT/GB2011/051157

§ 371 Date: Feb. 26, 2013

(30) Foreign Application Priority Data
Jun. 22, 2010 (GB) 1010396.8
Feb. 10, 2011 (GB) 1102379.3

(51) Int. Cl. A21C 15/04; B26D 7/10; B26D 7/01; B26D 3/24; B26D 5/00

(52) U.S. Cl. CPC A21C 15/04; B26D 3/24; B26D 5/00; B26D 7/01; B26D 7/10
USPC 83/13; 83/648; 83/821; 83/72; 83/171

(57) ABSTRACT

This invention relates to an apparatus for cutting a foodstuff into portions, and a method of portioning foodstuffs. A cutting apparatus (1) for foodstuffs (14) comprises a support surface (20) for supporting a foodstuff (14), a retaining member (38) movable relative to the support (20) surface between a first position at a first distance from said surface and a second position at a second distance from said surface, and cutting means (46) secured to the retaining member (38) such that, in use, when the retaining member (38) is moved from the first position to the second position, the cutting means (469 cuts the foodstuff (14) placed on the support surface (20), wherein the cutting means (46) and support surface (20) are movable relative to each other, at least a component of the movement being in a plane parallel to the support surface (20), such that, in use, two or more cuts can be made in the foodstuff (14) at different positions.

### BACKGROUND

a. Field of the Invention

This invention relates to an apparatus for cutting a foodstuff into portions, and a method of portioning foodstuffs. In particular, this invention relates to an apparatus and method for portioning cakes.

b. Related Art

It is known within the catering industry that it is difficult to slice cakes and desserts into equal portions using just a knife. This can prove to be extremely costly as you can be left with unsalable small portions if the slices are cut unevenly, meaning that at least some of the profit is lost.

Furthermore, many cakes and gateaux served are very soft, often formed from multiple layers including fruit and cream. These cakes are very difficult to cut cleanly with a knife. This can lead to wastage of some of the cake as a knife blade may simply squash parts of the cake.

Similar problems also exist in relation to other foodstuffs. It is, therefore, an object of the present invention to provide an improved apparatus and method for cutting a foodstuff into portions.

### SUMMARY OF THE INVENTION

According to the invention, there is provided a cutting apparatus for foodstuffs, the cutting apparatus comprising:
a support surface for supporting a foodstuff;
a retaining member movable relative to the support surface between a first position at a first distance from said surface and a second position at a second distance from said surface; and
cutting means secured to the retaining member such that, in use, when the retaining member is moved from the first position to the second position, the cutting means cuts said foodstuff placed on the support surface;
wherein the cutting means is a wire, and the wire and support surface are movable relative to each other, at least a component of the movement being in a plane parallel to the support surface, such that, in use, two or more cuts can be made in the foodstuff at different positions.

The cutting means and support surface may be movable relative to each other in a plane parallel to the support surface. Preferably, the movement between a first position and a second position defines a first axis of movement, and the support surface is perpendicular to this axis. Preferably the support surface is movable and the cutting means is stationary.

In some embodiments it is preferable if the relative movement of the cutting means and support surface is translational movement such that slices may be cut, for example, in a square or oblong foodstuff. In other embodiments it is preferable if the cutting means and support surface are rotatable with respect to each other about a rotational axis such that, in use, two or more cuts can be made in the foodstuff at different orientations. This is desirable if the apparatus is used to cut slices in a round cake for example.

Preferably the rotational axis is perpendicular to the support surface. More preferably the movement of the retaining member between a first position and a second position defines a first axis of movement, and the rotational axis is parallel to the first axis of movement.

The second distance may be less than the first distance.

Preferably the wire is attached to the retaining means at each end of the wire and the wire extends fully across a width of the support surface. This has the advantages that the attachment points between the wire and the retaining means are clear of the foodstuff placed on the support surface during the cutting operation and the foodstuff may be cut across its full width in a single operation.

Preferably the apparatus further comprises a guide post, and the retaining member is slidably connected to the guide post to permit movement of the retaining member between the first position and the second position. It may be preferable for the apparatus to comprise more than one guide post to allow a greater force to be applied to the cutting means.

Preferably the apparatus further comprises first sensing means to detect when the retaining member is in the first position and second sensing means to detect when the retaining member is in the second position.

In embodiments in which there is rotational movement between the support surface and the cutting means, it is preferable if the apparatus further comprises rotational control means for controlling an angle through which the cutting means and support surface rotate with respect to each other. This enables a chosen number of equal-sized portions to be cut from the foodstuff for example. Preferably the control means comprises electronic circuitry including a microchip for causing rotation through fixed angles depending on the number of portions, and therefore the number of cuts to be made in the foodstuff.

Preferably the support surface is a surface of a plate, however, the support surface may be a surface of a rotatable drum.

Preferably the apparatus further comprises heating means for heating the cutting means. More preferably the apparatus comprises a heated cutting wire.

The invention further provides a method of portioning foodstuffs using an apparatus according to the invention, wherein the method comprises the steps of:
placing a foodstuff on the support surface;
cutting the foodstuff by moving the retaining member from the first position to the second position; and
moving the cutting means and support surface relative to each other to enable a further cut to be made in the foodstuff at a different position.

Preferably the method comprises the steps of (a) placing a foodstuff on the support surface, (b) moving the retaining member from the first position to the second position so as to cut the foodstuff, (c) returning the retaining member to the first position from the second position, (d) moving the support surface with respect to the cutting means, and (e) repeating steps (b)-(d) until the required number of cuts have been made so as to portion the foodstuff.

In some embodiments the step of moving the support surface with respect to the cutting means comprises rotating the support surface.

### BRIEF DESCRIPTION OF THE DRAWINGS

The invention with now be further described, by way of example only, and with reference to the following drawings in which:

FIG. 1 is a perspective view of a cutting apparatus for cutting a cake or similar into portions according to a first preferred embodiment of the present invention;

FIG. 2 is a plan view from the front of the cutting apparatus of FIG. 1;

FIG. 3 is a plan view from the side of the cutting apparatus of FIG. 1, with the cake removed for clarity;

FIG. 4 is a plan view from the side of a cutting apparatus for cutting a cake or similar into portions according to a second preferred embodiment of the present invention;

FIG. 5 is a plan view from the side of a cutting apparatus for cutting a cake or similar into portions according to a third preferred embodiment of the present invention; and

FIG. 6 is a perspective view of an alternative cutting device for cutting a cake or similar into equal portions.

### DETAILED DESCRIPTION

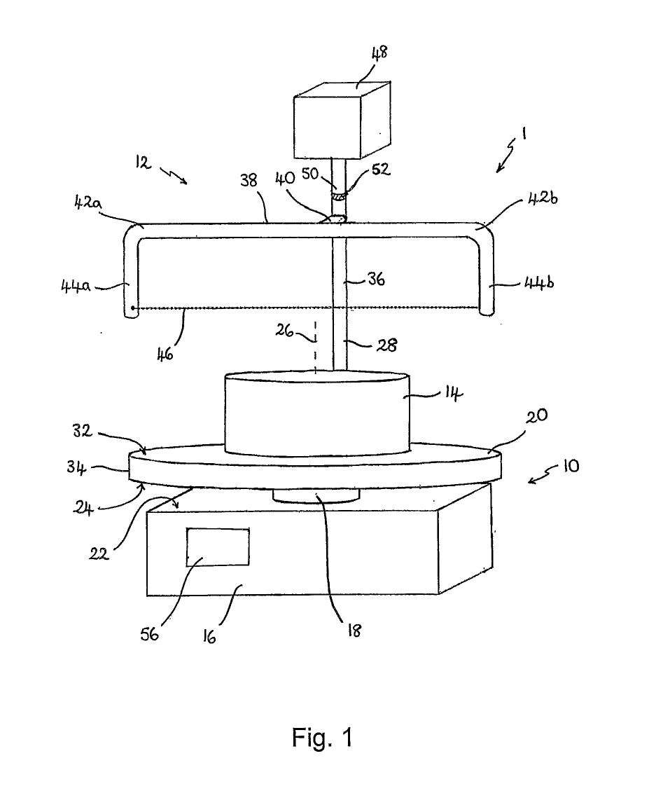

FIGS. 1 to 3 show a cutting apparatus 1 according to a first preferred embodiment of the present invention. The cutting apparatus 1 comprises a support assembly 10 and a cutter assembly 12. The cutter assembly 12 and support assembly 10 are movable with respect to each other so that an object to be cut, for example a foodstuff such as a cake 14 or the like, placed on the support assembly 10 may be cut by a part of the cutter assembly 12.

The support assembly 10 comprises a base housing 16, a spindle 18 and a support plate 20. In this embodiment, the base housing 16 has a substantially rectangular cross-sectional shape and forms a stable base for the remainder of the cutting apparatus 1. The base housing 16 also contains a first motor 17 and electronic circuitry 19 which will be described in more detail later.

The spindle or axle 18 extends perpendicularly through an aperture in an upper face 22 of the base housing 16. In this way, a first, lower end of the spindle 18 is within the housing 16 and a second, upper end of the spindle 18 is at a distance above the upper face 22.

The support plate 20 is attached by a lower, rear face 24 to the upper end of the spindle 18. The support plate 20 lies in a plane parallel to but spaced apart from the upper face 22 of the base housing 16. In this embodiment, the support plate 20 is a circular disc, and the spindle 18 is fixed to the centre of the lower face 24 of the support plate 20 such that both the spindle 18 and the support plate 20 are rotatable about a longitudinal axis 26 perpendicular to the support plate 20.

The support plate 20 is connected to the motor unit 17 in the base housing 16 via the spindle 18, and the motor 17 drives the rotation of the support plate 20 as will be described in more detail later.

A guide post 28 is fixed at a first, lower end to the base housing 16. The guide post 28 extends upwards from the base housing 16 such that a second, upper end 30 of the guide post 28 is at a distance above an upper surface 32 of the support plate 20. In this way, the guide post 28 is parallel to but offset from the longitudinal axis 26 such that there is a gap between an outer circumferential edge 34 of the support plate 20 and the guide post 28. This clearance between the plate 20 and the post 28 permits the support plate 20 to rotate freely in use. In some embodiments in which the diameter of the support plate 20 is less than the width of the base housing 16, the guide post 28 may extend from the upper face 22 of the housing 16. In the present embodiment, the diameter of the support plate 20 is greater than the width of the base housing 16. In this example, therefore, the guide post 28 comprises a first portion 35 that extends substantially horizontally, and perpendicular to the rotational axis 26, from a side 15 of the base housing 16 and a second portion 36 that extends substantially vertically, and parallel to the rotational axis 26. Preferably the first and second portions 35, 36 of the guide post 28 are integrally formed.

A retaining member or arm 38 is slidably connected to the guide post 28 at a first end of a stem portion 40. The stem portion 40 extends horizontally from the guide post 28 towards the rotational axis 26, and the length of the stem portion 40 is such that a second end of the stem portion 40 is in line with the rotational axis 26. The retaining arm 38 further comprises two substantially L-shaped branch portions 42a, 42b, and in this embodiment, the two branch portions 42a, 42b are integrally formed.

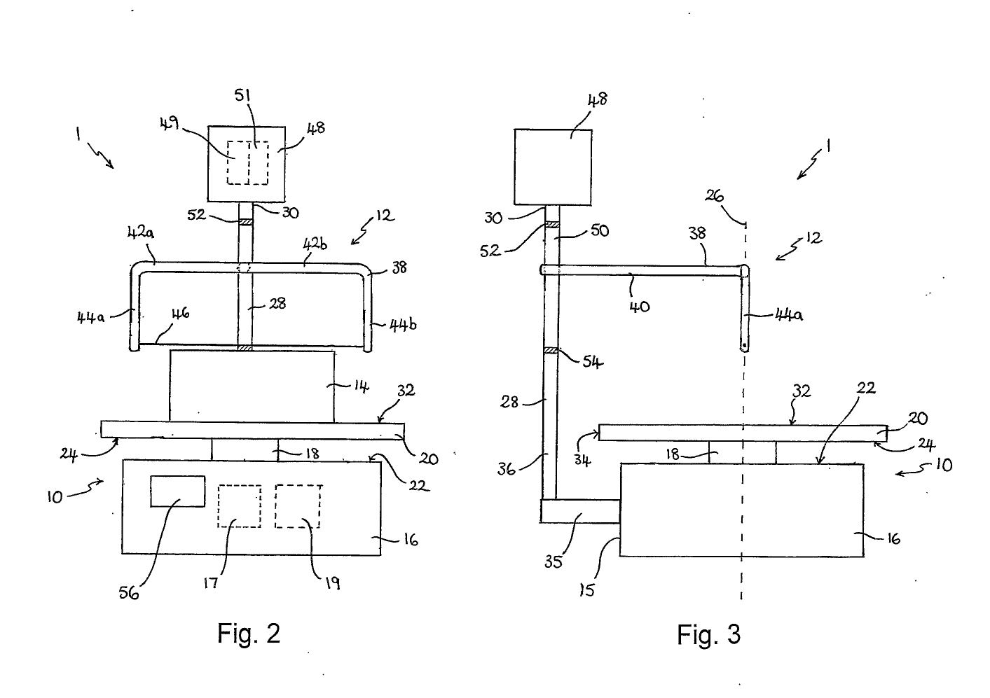

Each of the L-shaped branch portions 42a, 42b extends, in an opposing direction, perpendicularly from the second end of the stem portion 40. End regions 44a, 44b of the branch portions 42a, 42b are bent at right angles to the rest of the branch portions 42a, 42b, so that the end regions 44a, 44b extend generally vertically downwards towards the upper surface 32 of the support plate 20. Preferably the horizontal distance between the end regions 44a, 44b is approximately the same as the diameter of the support plate 20, although the distance may be less than the diameter of the support plate 20, as shown in FIG. 2.

Cutting means 46 in the form of a metallic wire 46 is attached by each end to a respective end region 44a, 44b of the retaining arm 38 such that the wire 46 extends horizontally across the space between the end regions 44a, 44b. Suitable attachment means are used at each end of the wire 46 to enable the wire to be held taut between the end regions 44a, 44b.

In this embodiment, a second motor unit 48 is mounted at the upper end 30 of the guide post 28. In other embodiments, the motor unit 48 may be positioned in any suitable location in or on the cutting apparatus 1, for example in the base housing. The motor unit 48 comprises a motor 49 and control circuitry 51 used to control and drive movement of the retaining arm 38 reciprocally along the guide post 28. In particular, the retaining arm 38 is driven in a first, downwards direction from an upper region 50 of the guide post 28 towards the support plate 20, and in a second, upwards direction, opposite to the first direction, away from the support plate 20 towards the upper region 50 of the guide post 28.

Sensing means are provided to limit movement of the retaining arm 38 up and down the guide post 28. In this embodiment, the sensing means comprises first and second switches 52, 54 attached to the guide post 28. The first, upper limit switch 52 is provided on the guide post 28 in the upper region 50, and defines the upper limit of movement of the retaining arm 38. The second, lower limit switch 54 is provided in a lower region of the guide post 28, and limits the downward movement of the retaining arm 38. Outputs from the switches 52, 54 are linked to the control circuitry 51, which in this embodiment comprises a microcontroller 51, which in turn controls the operation of the motor 49 in the second motor unit 48.

Rotation of the support plate 20 is controlled by electronic circuitry 19 linked to the motor unit 17. In this embodiment, the electronic circuitry 19 comprises a programmable microchip 19. In particular, the microchip 19 is preset with a number of programs corresponding to the apparatus 1 cutting the cake 14 into different numbers of segments. For example, the program to slice the cake into sixteen portions includes commands to rotate the support plate 20 through 22.5° about the rotational axis 26, and further includes a command to stop rotating the cake and end the program once eight rotations have occurred. Input means 56 may be provided to allow a user of the apparatus 1 to input the desired number of segments. The input means 56 may be in the form of a keypad on a face of the base housing 16.

The operation of the cutting apparatus 1 will now be described in relation to slicing a cake 14 into twelve equal segments.

With the retaining arm 38 in a first raised position in the upper end region 50 of the guide post 28, a cake 14 or similar object to be cut into segments is placed on the upper support surface 32 of the support plate 20. A reset button (not shown) may be provided on the apparatus 1 that, when pressed, causes the retaining arm 38 to return to the raised position. Alternatively, when the apparatus 1 is switched on, the retaining arm 38 may be automatically reset to the raised position. A user then inputs the number of portions required using the input means 56 and activates the apparatus 1.

The motor 49 lowers the retaining arm 38 from the upper region 50 of the guide post 28 and, as the retaining arm 38 moves down the guide post 28, the cutting wire 46 slices through the cake 14. When the arm 38 reaches the lower switch 54 the direction of movement is reversed and the retaining arm 38 moves back up the guide post 28 to the raised position. The position of the lower switch 54 is such that, when the arm 38 contacts the switch 54, the cutting wire 46 has passed fully through the cake 14, but does not press too deeply into the support surface 32. In other embodiments, the lower switch 54 may be positioned such that the wire 46 has not cut completely through the cake 14 so that a base region of the cake remains intact and the wire 46 does not contact the support surface 32.

When the retaining arm 38 contacts the upper switch 52, movement of the retaining arm 38 is stopped. A signal is sent to the microcontroller 51 indicating that the arm 38 is in the raised position. The microcontroller 51 then sends an output signal to the motor 17 in the base housing 16 to rotate the support plate 20 through a set angle depending on the number of portions a user has inputted. For example for a cake to be cut into twelve slices, the cake is rotated by 30° about the rotation axis 26. Once the support plate 20 has been rotated, a signal is sent back to the control circuitry 51 in the second motor unit 48 and the retaining arm 38 is lowered again to perform a second cutting action, the same as that described above.

These steps of rotation and cutting are repeated until the cake 14 has been cut into the required number of slices. In a preferred embodiment, the apparatus 1 includes an indicator (not shown) to indicate when the cutting program is finished. The indicator may be in the form of a light emitting diode, for example, that illuminates when cutting is completed.

In this way, the cutting apparatus 1 of the present invention provides a device that slices a cake or similar into equal sized segments.

In some embodiments of the present invention, the cutting apparatus 1 further includes heating means (not shown). The heating means are connected to the cutting means 46 so that the cutting means may be heated if desired. Preferably, the heating means further includes control means so that the cutting means may be heated to different temperatures depending on the application for which the cutting apparatus is being used. The heating means are preferably controlled via an input from the user at the input means 56.

In some embodiments of the cutting apparatus 1 the cutting means 46 is a blade. A blade provides stronger cutting means 46 allowing tougher items to be sliced, which may be difficult to slice with a wire, for example fruit cake or frozen items. In some embodiments, the blade may be made of stainless steel.

It may also be desirable, in some embodiments, to include more than one guide post 28. For example, two opposing guide posts 28 may be provided supporting each end of a single retaining member 38 spanning the distance between them. Alternatively, a separate retaining member may be provided slidably attached to each guide post and the cutting means may be held between respective free ends of each of the retaining members. In other embodiments, any suitable number of guide posts may be used.

In other embodiments, the electronic circuitry 19 comprises a rotational sensor in the support assembly, preferably on an upper surface of the base housing below the support plate. The rotational sensor is used to detect the rotational position of the support plate. In these embodiments, several interchangeable support plates are provided. Each plate includes, on a lower surface, a series of indicating markers corresponding to a different number of portions. For example, a support plate for cutting twelve portions includes twelve markers spaced equidistantly around the plate proximate the circumferential edge. The rotational sensor senses the position of the markers as the plate rotates and thereby controls the rotational movement of the support plate during the cutting operation to cut the required number of portions.

In the foregoing description the cutting apparatus 1 has been described as having a support surface 32 that rotates below the cutting means 46. In other embodiments, the support surface 32 may remain stationary and the cutting means 46 may rotate about the rotational axis 26. In particular, means may be provided to rotate the guide post 28 around the edge 34 of the support plate 20. This has the advantage of not rotating a delicate cake 14 of other foodstuff placed on the support surface 32 during the cutting process.

FIG. 4 shows a cutting apparatus 101 according to a second preferred embodiment of the present invention that may be used to cut square or oblong cakes for example. The cutting apparatus 101 is similar to the previous embodiment described above and similar features will be referenced with numerals incremented by 100. The cutting apparatus 101 comprises a support assembly 110 and a cutter assembly 112 substantially the same as that described above.

As in the previous embodiment, the support assembly 110 comprises a base housing 116 and a support plate 120.

The cutter assembly 112 comprises a guide post 128 fixed at a first, lower end to the base housing 116. The guide post 128 extends upwards from the base housing 116 such that a second, upper end 130 of the guide post 128 is at a distance above an upper surface 132 of the support plate 120. In some embodiments in which the dimensions of the support plate 120 are smaller than those of the base housing 116, the guide post 128 may extend from an upper face 122 of the housing 116.

In this example the guide post 128 comprises a first portion 135 that extends substantially horizontally from a side 115 of the base housing 116 and a second portion 136 that extends substantially vertically. Preferably the first and second portions 135, 136 of the guide post 128 are integrally formed.

A retaining member or arm 138 is slidably connected to the guide post 128 at a first end of a stem portion 140. The stem portion 140 extends horizontally from the guide post 128 above the support plate 120, and the length of the stem portion 140 is such that the stem portion 140 extends fully across a width of the support plate 120. The retaining arm 138 further comprises two substantially L-shaped branch portions 142 as previously described. End regions 144 of the branch portions extend generally vertically downwards towards the support plate 120.

Cutting means 146 in the form of a metallic wire 146 is attached by each end to a respective end region 144 of the retaining arm 138 such that the wire 146 also extends horizontally across the support plate 120.

A motor unit 148 comprising a motor 149 and control circuitry 151 is used to control and drive both movement of the stem portion 140 of the retaining arm 138 reciprocally up and down along the guide post 128, and also movement of the branch portions 142 reciprocally along the stem portion 140, as indicated by the arrows in FIG. 4.

Sensing means are provided both to limit movement of the stem portion 140 up and down the guide post 128 and also to limit movement of the branch portions 142 along the stem portion 140. In this embodiment, the sensing means comprises first and second switches 152, 154 attached to the guide post 128, and third and fourth switches 153, 155 attached to the stem portion 140. The first and second switches 152, 154 are positioned and function as described above in relation to the first embodiment of the invention. The third and fourth limit switches 153, 155 determine the extent of lateral movement of the cutting means 146 across the stem portion 140, and therefore across the support plate 120.

Outputs from the switches 152-155 are linked to the control circuitry 151, which in this embodiment comprises a microcontroller 151, which in turn controls the operation of the motor 149 in the motor unit 148.

In a preferred embodiment, the apparatus 101 includes an indicator (not shown) to indicate when the cutting program is finished. The indicator may be in the form of a light emitting diode, for example, that illuminates when cutting is completed.

In some embodiments, the cutting apparatus 101 further includes heating means (not shown). The heating means are connected to the cutting means 146 so that the cutting means may be heated if desired.

Input means (not shown) may also be provided on the apparatus 101 to allow a user to input the required portions in order to control the cutting operation.

In circumstances in which the apparatus 101 is used to slice an oblong cake, the cutting means 146 is moved along the stem portion 140 in discrete steps and a cutting action, in which the stem portion 140 is lowered down the guide post 128 as previously described, is performed at each step position so as to cut the cake 114 into slices.

In some embodiments, the base housing 116 further includes a spindle 118 to permit rotation of the support plate 120. In these embodiments, the support plate 120 is connected to a motor unit 117 in the base housing 116 via the spindle 118, and the motor 117 drives the rotation of the support plate 120. Rotation of the support plate 120 is controlled by electronic circuitry 119 linked to the motor unit 117. In this embodiment, the electronic circuitry 119 comprises a programmable microchip 119 programmed to rotate the support plate 120 through 90° during the cutting operation as described below.

The operation of the cutting apparatus 101 will now be described in relation to cutting a square cake 114 into sixteen equally-sized square pieces.

With the retaining arm 138 in a first raised position a cake 114 or similar object to be cut into segments is placed centrally on the upper support surface 132 of the support plate 120, and the user inputs the required number of portions. In a first step the motor 149 moves the cutting wire 146 along the stem portion 140 until it is positioned one quarter of the way across the width of the cake 114. The motor then lowers the retaining arm 138 so that the cutting wire 146 slices through the cake 114. The direction of movement of the arm 138 is reversed and the retaining arm 138 moves back up the guide post 128 to the raised position. A second step moves the cutting wire 146 along the stem portion 140 until it is positioned half way across the width of the cake 114, and the cutting action is repeated. A third step moves the cutting wire 146 along the stem portion 140 until it is positioned three quarters of the way across the width of the cake 114, and the cutting action is repeated. The motor 117 in the base housing 116 then rotates the support plate 120 through 90°, and the cutting actions described above are repeated so as to cut the cake 114 into square portions.

In a different embodiment or operational mode, the sixteen portions may be cut using a different combination of cutting and rotating actions. In particular, in a first step the motor 149 moves the cutting wire 146 along the stem portion 140 until it is positioned one quarter of the way across the width of the cake 114. A cutting action is then performed. The support plate 120 is rotated by 90° and a second cutting action is performed. Two further rotations through 90° are then made, each followed by a corresponding cutting action. In a second step, the motor 149 moves the cutting wire 146 along the stem portion 140 until it is positioned half way across the width of the cake 114 and a cutting action is performed. The cake is then rotated through a final 90° and a final cutting action is performed. This also results in the cake 114 being cut into square portions.

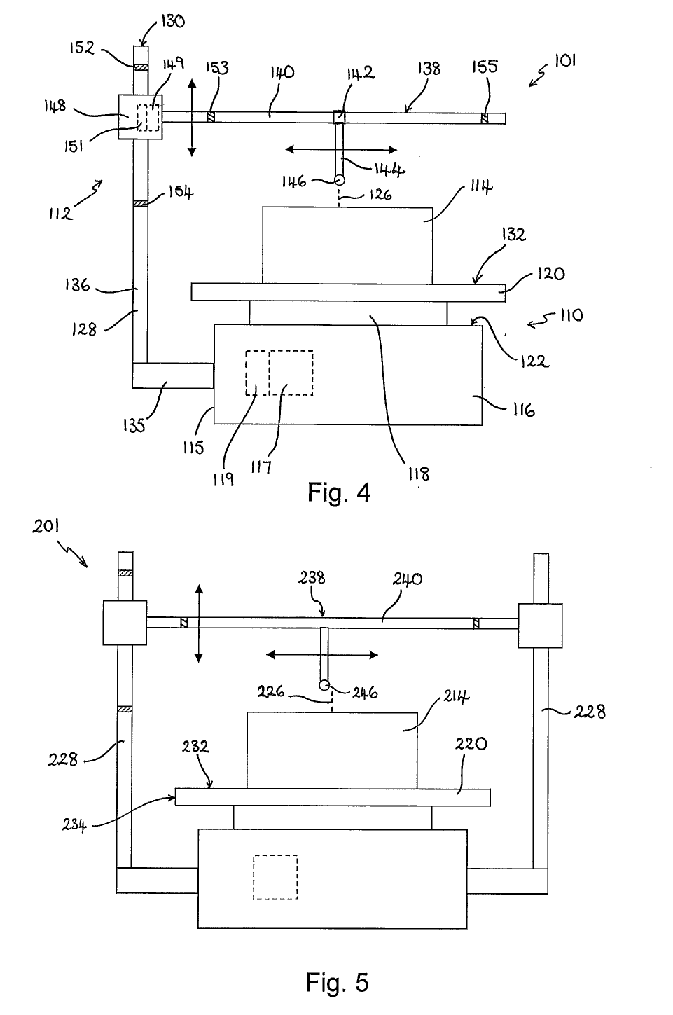

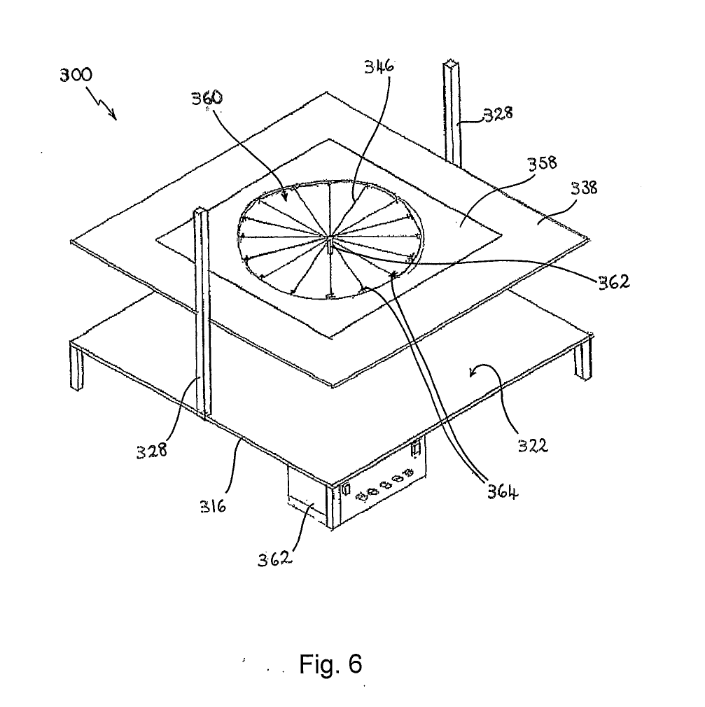

FIG. 5 shows a further embodiment of the invention. This embodiment is substantially the same as that described above in relation to FIG. 4, but the apparatus 201 comprises two opposing guide posts 228 supporting each end of the stem portion 240 of the retaining member 238. In this way, the stem portion 240 spans the space between the guide posts 228, thereby spanning the support plate 220.

Although the cutting apparatus 101, 201 has been described as having cutting means 146, 246 that traverses the width of the cake or similar 114, 214 and a support surface 132, 232 that rotates below the cutting means 146, 246, in other embodiments movement of the cutting means 146, 246 and support plate 120, 220 may be different. In particular, the support plate 120, 220, and therefore the support surface 132, 232, may be movable in directions perpendicular to the rotational axis 126, 226 as well as rotatable about the axis 126, 226. In these embodiments, the cutting means 146, 246 remains in a fixed position relative to the guide post 128, 228 at all times. In other embodiments, means may be provided to rotate the guide post or posts 128, 228 around the edge 134, 234 of the support plate 120, 220. This has the advantage of not rotating or otherwise moving a delicate cake 114, 214 of other foodstuff placed on the support surface 132, 232 during the cutting process.

In the embodiments described above, the cutting means 46, 146, 246 are moved down to a position at or above the support surface 32, 132, 232 during the cutting action. In alternative embodiments, the support plate 20, 120, 220 may comprise slots or grooves through which or into which the cutting wire 46, 146, 246 may move. These allow the wire 46, 146, 246 to move to a position below the level of the support surface 32, 132, 232. In these embodiments, in which the wire 46, 146, 246, or other cutting means 46, 146, 246, may be located below or in the slot or groove, means may be provided to rotate the cake 14, 114, 214 when the wire 46, 146, 246 is located below the support surface 32, 132, 232. In this way, a subsequent cutting action draws the wire 46, 146, 246 up through the cake or other foodstuff 14, 114, 214.

FIG. 6 shows a cake and dessert portioner 300 comprising a base unit 316, including a low voltage motorised control unit 362, and a travelling platform 338. The travelling platform 338 is supported by parallel vertical guides 328 that retain the platform 338 in the correct position relative to the base unit 316 and permit the vertical movement of the platform 138 towards and away from the base unit 316.

The travelling platform 338 comprises a retaining frame 358 including a circular cut-out 360. A plurality of wires 346 are connected across the cut-out 360, and in this embodiment there are a number of wires 346 located across the diameter of the circular cut-out 360. Each of the wires 346 are located at an angle to each of the other wires so that the ends of the wires, at the edge of the cut-out 360, are spaced equidistantly around the circumference of the cut-out. In this way, the wires 346 cross at a single central point. At this central point, a heating rod 362 extends for a distance vertically downwards from the wires 346 towards the base unit 316. The ends of each of the wires 346 are connected to the retaining frame 358 by means of a tension spring 364. The springs 364 allow the wires 346 to move with respect to the retaining frame 358 when a force is exerted on them during cutting of a cake or similar, however, the springs 364 also provide a tensile restoring force on the wires 346, retuning them to their original positions when the cutting operation is finished. This decreases the likelihood of the wires 346 becoming permanently stretched or damaged by repeated cutting actions. The retaining frame 358 and wires 346 are centrally situated in the travelling platform 338 and between the two vertical guides 328.

The portioner 300 may be used in two different states. In a first cold wire state, the wires 346 are not heated. This may be desirable for cutting cakes including fresh fruit for example. In a second hot wire state, the wires 346 are heated. This state may be used to portion a frozen dessert for example.

In the particular embodiment of the cake and dessert portioner 300 shown in FIG. 6, the portioner 300 comprises a retaining frame 358 having a circular cut-out 360 with a diameter of 325 mm. The wires 346 are arranged such that each wire 346 is at an angle of 36° to the two neighbouring wires 346. In this way, the wires 346 are arranged to cut 10 equal portions in a cake or similar.

In use, a cake or similar is placed on the upper surface 322 of the base unit 316. To cut the cake, the motorised control unit 362 is used to move the retaining frame 358 and wires 346 down at a first speed towards the base unit 316, thereby cutting into the cake or dessert and portioning it into equal portions. Once the cake has been cut, the travelling platform 338 moves back up the vertical guides at a second speed. The first and second speeds may be equal or the first and second speeds may be different.

In order to adapt the portioner 300 to cut different number of portions, the retaining frame 358 is removable. As such a number of different frames may be interchanged to provide wires 346 at different angles to cut different numbers of portions. For example, the wires 346 may be arranged to cut 10, 12, 14, 16 portions. Furthermore, the cut-out 360 in the retaining frame 358 may be manufactured in various diameters, for example, ranging from 225 mm to 325 mm to accommodate different sizes of cake.

Although in this embodiment the portioner 300 has been shown in an arrangement to cut circular cakes, the portioner 300 may be adapted to cut square or rectangular cakes. In these embodiments, the cut-out 360 formed in the retaining frame 358 is square or rectangular, and the wires 346 are located across the width of the cut-out 360. Alternatively the wires 346 may be located lengthwise along the cut-out 360, or two sets of wires 346 could be held at right angles so as to be able to cut squares of cake for example.

The cake and dessert portioner must be manufactured from materials suitable for use with hot wires compliant with EU Law and Health & Safety. The hot wire cake and dessert portioner can be manufactured from materials that are either round or square in cross section.

The number of portions may be controlled by adjustable wires. Preferably the portioner has between 1 and 20 wires.

The cake and dessert portioner described in this embodiment, therefore, provides an easy means of slicing cakes and desserts into equal portions. The portioner comprises a moveable frame that moves up and down on the travelling platform between vertical guides.

In some embodiments, the wires of the portioner are heated by a low voltage motorised control unit. Preferably, the control unit heats the central rod, and the central rod heats the wires. Alternatively the portioner can be used with cold wires.

References in the foregoing description to upper, lower, upwards, downwards, horizontal, vertical etc are references to the orientation of the embodiments of the invention as shown in the figures. It will be appreciated that in other embodiments the cutting apparatus may have a different orientation while still fulfilling the intended function.

References in the foregoing description to cakes and the like, or cakes and similar, are references to any suitable items that may be sliced by the cutting apparatus of the present invention. These items include, in particular, foodstuffs such as pies, sponge cakes, fruit cakes, cheesecakes, quiches, flans and tarts.

The invention described above, therefore, provides an improved apparatus and method for cutting a foodstuff, especially cakes, into portions.

1. A cutting apparatus for foodstuffs, the cutting apparatus comprising:
a support surface for supporting a foodstuff;
a retaining member movable relative to the support surface between a first position at a first distance from said surface and a second position at a second distance from said surface; and
cutting means secured to the retaining member such that, in use, when the retaining member is moved from the first position to the second position, the cutting means cuts said foodstuff placed on the support surface;
wherein the cutting means is a wire, and the wire and support surface are movable relative to each other, at least a component of the movement being in a plane parallel to the support surface, such that, in use, two or more cuts can be made in the foodstuff at different positions.

2. A cutting apparatus as claimed in claim 1, wherein the cutting means and support surface are movable relative to each other in a plane parallel to the support surface.

3. A cutting apparatus as claimed in claim 1 wherein said movement between a first position and a second position defines a first axis of movement, and the support surface is perpendicular to the axis.

4. A cutting apparatus as claimed in claim 1, wherein said relative movement of the cutting means and support surface includes translational movement.

5. A cutting apparatus as claimed in claim 1, wherein the cutting means and support surface are rotatable with respect to each other about a rotational axis such that, in use, two or more cuts can be made in the foodstuff at different orientations.

6. A cutting apparatus as claimed in claim 5, wherein the rotational axis is perpendicular to the support surface.

7. A cutting apparatus as claimed in claim 6, wherein said movement between a first position and a second position defines a first axis of movement, and the rotational axis is parallel to the first axis of movement.

8. A cutting apparatus as claimed in claim 1, wherein the second distance is less than the first distance.

9. A cutting apparatus as claimed claim 1, wherein the wire is attached to the retaining means at each end of the wire.

10. A cutting apparatus as claimed claim 1, wherein the wire extends fully across a width of the support surface.

11. A cutting apparatus as claimed in claim 1, wherein the apparatus further comprises a guide post, and the retaining member is slidably connected to the guide post.

12. A cutting apparatus as claimed in claim 11, wherein the apparatus comprises more than one guide post.

13. A cutting apparatus as claimed in claim 1, wherein the apparatus further comprises first sensing means to detect when the retaining member is in the first position and second sensing means to detect when the retaining member is in the second position.

14. A cutting apparatus as claimed in claim 5, wherein the apparatus further comprises rotational control means for controlling an angle through which the cutting means and support surface rotate with respect to each other.

15. A cutting apparatus as claimed in claim 14, wherein the control means comprises electronic circuitry including a microchip for causing rotation through fixed angles depending on the number of cuts to be made in the foodstuff.

16. A cutting apparatus as claimed in claim 1, wherein the support surface is a surface of a plate.

17. A cutting apparatus as claimed in claim 1, wherein the support surface is a surface of a rotatable drum.

18. A cutting apparatus as claimed in claim 1, wherein the apparatus further comprises heating means for heating the cutting means.

19. A cutting apparatus as claimed in claim 1, wherein the support surface is movable and the cutting means is stationary.

20. A method of portioning foodstuffs using an apparatus as claimed in claims 1, wherein the method comprises the steps of:
placing a foodstuff on the support surface; cutting the foodstuff by moving the retaining member from the first position to the second position; and
moving the cutting means and support surface relative to each other to enable a further cut to be made in the foodstuff at a different position.

21. A method of portioning foodstuffs as claimed in claim 20, wherein the method comprises the steps of:
a) placing a foodstuff on the support surface;
b) moving the retaining member from the first position to the second position so as to cut the foodstuff;
c) returning the retaining member to the first position from the second position; d) moving the support surface with respect to the cutting means; and
e) repeating steps b)-d) until the required number of cuts have been made so as to portion the foodstuff.

22. A method of portioning foodstuffs as claimed in claim 21, wherein the step of moving the support surface with respect to the cutting means comprises rotating the support surface.

23. (canceled)

24. (canceled)
